(19) United States
(12) Patent Application Publication
(10) Pub. No.: US 2021/0103467 A1
(43) Pub. Date: Apr. 8, 2021

(54) SHADER CONTROLLED WAVE SCHEDULING PRIORITY

(71) Applicant: QUALCOMM Incorporated, San Diego, CA (US)

(72) Inventors: Elina Kamenetskaya, Belmont, MA (US); Andrew Evan Gruber, Arlington, MA (US); Alexei Vladimirovich Bourd, San Diego, CA (US)

(21) Appl. No.: 16/591,349

(22) Filed: Oct. 2, 2019

(51) Int. Cl. G06F 9/48; G06F 9/50; G06T 15/00

(52) U.S. Cl. CPC G06F 9/4881; G06T 15/005; G06F 9/5038

(57) ABSTRACT

A graphics processing unit (GPU) may execute a shader program that may include instructions for prioritization and scheduling of waves processed in parallel. According to some aspects of the described techniques, instruction variants (e.g., set-lowest-priority, set-highest-priority, set-priority-to-N, etc.) may be executed by hardware during processing of a wave to control (e.g., modify) processing priority for that wave. As such, the described techniques for shader controlled wave scheduling priority may allow waves to be processed while avoiding interference with lagging waves, while avoiding taking resources from lagging waves, etc. In one example, when a set-lowest-priority instruction is executed by hardware during execution of a first loop of a first wave, the instruction may push the current wave's priority to be lowest on the list. Such may result in pending loops from other waves being processed prior to the processing returning to a second loop of the first wave.

### BACKGROUND

The following relates generally to graphics processing, and more specifically to shader controlled wave scheduling priority.

Multimedia systems are widely deployed to provide various types of multimedia communication content such as voice, video, packet data, messaging, broadcast, and so on. These multimedia systems may be capable of processing, storage, generation, manipulation and rendition of multimedia information. Examples of multimedia systems include entertainment systems, information systems, virtual reality systems, model and simulation systems, and so on. These systems may employ a combination of hardware and software technologies to support processing, storage, generation, manipulation and rendition of multimedia information, for example, such as capture devices, storage devices, communication networks, computer systems, and display devices.

For example, a graphics processing unit (GPU) may represent one or more dedicated processors for performing graphical operations. A GPU may be a dedicated hardware unit having fixed function and programmable components for rendering graphics and executing GPU applications. In some cases, a GPU may implement a parallel processing structure that may provide for more efficient processing of complex graphic-related operations. For example, a GPU may include a plurality of processing elements that are configured to operate in a parallel manner, which may allow the GPU to generate graphic images for display (e.g., for graphical user interfaces, for display of two-dimensional or three-dimensional graphics scenes, etc.).

### SUMMARY

The described techniques relate to improved methods, systems, devices, or apparatuses that support shader controlled wave scheduling priority. Generally, the described techniques provide for shader (e.g., graphics program) control of graphics processing unit (GPU) parallel processing. For example, a GPU may execute a shader program that may include instructions for prioritization and scheduling of waves processed in parallel, which may provide for thread synchronization and optimization of GPU resources for improved parallel processing of various workloads.

According to some aspects of the described techniques, a shader may implement instruction variants (e.g., set-lowest-priority, set-highest-priority, set-priority-to-N, etc.) that may be executed by GPU hardware during wave processing to control (e.g., modify) wave scheduling priority. As such, the described techniques for shader controlled wave scheduling priority may allow waves to be processed while avoiding interference with lagging waves, while avoiding taking resources from lagging waves, etc. In one example, when a set-lowest-priority instruction is executed by hardware during execution of a first loop of a first wave, the instruction may push the current wave's priority to be lowest on the list (e.g., in Eldest or Round-Robin priority schemes), raising the relative priority of all other waves. Such may result in pending loops from other waves being processed prior to the processing returning to a second loop of the first wave. According to some aspects of the described techniques, priority assignment may be dynamic (e.g., in Eldest/Round-Robin schemes, other waves may subsequently execute the set-lowest-priority instruction, such that the priority of the initial wave dynamically increases as subsequent waves are set to lowest priority).

A method of graphics processing at a device is described. The method may include identifying a set of threads of a graphics processing unit for executing a program, where each thread is associated with a priority. The method may further include beginning processing of a first thread of the set of threads based on the identified set of threads and the priority, modifying the priority of the first thread relative to a remainder of the set of threads based on beginning processing of the first thread, and processing the remainder of the set of threads and a remainder of the first thread based on the modified priority.

An apparatus for graphics processing at a device is described. The apparatus may include a processor, memory coupled with the processor, and instructions stored in the memory. The instructions may be executable by the processor to cause the apparatus to identify a set of threads of a graphics processing unit for executing a program, where each thread is associated with a priority. Additionally, the instructions may be executable by the processor to cause the apparatus to begin processing of a first thread of the set of threads based on the identified set of threads and the priority, modify the priority of the first thread relative to a remainder of the set of threads based on beginning processing of the first thread, and process the remainder of the set of threads and a remainder of the first thread based on the modified priority.

Another apparatus for graphics processing at a device is described. The apparatus may include means for identifying a set of threads of a graphics processing unit for executing a program, where each thread is associated with a priority. The apparatus may further include means for beginning processing of a first thread of the set of threads based on the identified set of threads and the priority, modifying the priority of the first thread relative to a remainder of the set of threads based on beginning processing of the first thread, and processing the remainder of the set of threads and a remainder of the first thread based on the modified priority.

A non-transitory computer-readable medium storing code for graphics processing at a device is described. The code may include instructions executable by a processor to identify a set of threads of a graphics processing unit for executing a program, where each thread is associated with a priority, begin processing of a first thread of the set of threads based on the identified set of threads and the priority, modify the priority of the first thread relative to a remainder of the set of threads based on beginning processing of the first thread, and process the remainder of the set of threads and a remainder of the first thread based on the modified priority.

Some examples of the method, apparatuses, and non-transitory computer-readable medium described herein may further include operations, features, means, or instructions for processing a first portion of the first thread based on beginning processing of the first thread, where the priority of the first thread relative to the remainder of the set of threads may be modified based on processing the first portion of the first thread. In some examples of the method, apparatuses, and non-transitory computer-readable medium described herein, the first portion of the first thread includes a first loop of a load operation, a long sync operation, and an arithmetic logic unit operation, and the remainder of the first thread includes one or more loops other than the first loop.

Some examples of the method, apparatuses, and non-transitory computer-readable medium described herein may further include operations, features, means, or instructions for determining one or more operations of the remainder of the set of threads may be of higher priority than the remainder of the first thread, where the priority of the first thread relative to the remainder of the set of threads may be modified based on the determination.

In some examples of the method, apparatuses, and non-transitory computer-readable medium described herein, modifying the priority of the first thread relative to the remainder of the set of threads may include operations, features, means, or instructions for processing a hardware priority control instruction within the program for the first thread that indicates the priority of the remainder of the first thread relative to the remainder of the set of threads. In some examples of the method, apparatuses, and non-transitory computer-readable medium described herein, the hardware priority control instruction may include operations, features, means, or instructions for a set-lowest-priority instruction, a set-highest-priority instruction, a lower-priority-by-N instruction, a raise-priority-by-N instruction, and a set-priority-to-N instruction. In some examples of the method, apparatuses, and non-transitory computer-readable medium described herein, the priority of the remainder of the first thread relative to the remainder of the set of threads may be modified based on a number of available arithmetic logic unit resources or a number of threads in the set of threads of the graphics processing unit.

In some examples of the method, apparatuses, and non-transitory computer-readable medium described herein, processing the remainder of the set of threads and the remainder of the first thread may include operations, features, means, or instructions for processing a first portion of each thread of the remainder of the set of threads, and processing the remainder of the first thread based on processing the first portion of each thread of the remainder of the set of threads. Some examples of the method, apparatuses, and non-transitory computer-readable medium described herein may further include operations, features, means, or instructions for modifying the priority of at least one thread of the remainder of the set of threads relative to the first thread based on processing the first portion of each thread of the remainder of the set of threads, where the remainder of the first thread may be processed based on the modified priority of the at least one thread of the remainder of the set of threads.

In some examples of the method, apparatuses, and non-transitory computer-readable medium described herein, processing the remainder of the set of threads and the remainder of the first thread based on the modified priority may include operations, features, means, or instructions for processing a first arithmetic logic unit operation associated with a second thread of the remainder of the set of threads, and processing a second arithmetic logic unit operation associated with the remainder of the first thread based on processing the first arithmetic logic unit operation associated with the second thread.

### BRIEF DESCRIPTION OF THE DRAWINGS

FIG. 1 illustrates an example of a system for graphics processing that supports shader controlled wave scheduling priority in accordance with one or more aspects of the present disclosure.

FIG. 2 illustrates an example of a device that supports shader controlled wave scheduling priority in accordance with one or more aspects of the present disclosure.

FIGS. 3A and 3B illustrate examples of processing diagrams that support shader controlled wave scheduling priority in accordance with one or more aspects of the present disclosure.

FIGS. 4 and 5 show block diagrams of devices that support shader controlled wave scheduling priority in accordance with one or more aspects of the present disclosure.

FIG. 6 shows a block diagram of a graphics manager that supports shader controlled wave scheduling priority in accordance with one or more aspects of the present disclosure.

FIG. 7 shows a diagram of a system including a device that supports shader controlled wave scheduling priority in accordance with one or more aspects of the present disclosure.

FIGS. 8 through 10 show flowcharts illustrating methods that support shader controlled wave scheduling priority in accordance with one or more aspects of the present disclosure.

### DETAILED DESCRIPTION

A graphics processing unit (GPU) may represent one or more dedicated processors for performing graphical operations. A GPU may be a dedicated hardware unit having fixed function and programmable components for rendering graphics and executing GPU applications. In some cases, a GPU may implement a parallel processing structure that may provide for more efficient processing of complex graphic-related operations. For example, a GPU may include a plurality of processing elements that are configured to operate in a parallel manner, which may allow the GPU to generate graphic images for display (e.g., for graphical user interfaces, for display of two-dimensional or three-dimensional graphics scenes, etc.).

In some cases, a GPU may execute a shader (e.g., a shader program, a graphics program, a computer program, etc.) to perform various specialized functions in various fields of computer graphics. For example, shaders may be used widely in cinema postprocessing, computer-generated imagery, multimedia display, video games, etc. (e.g., to produce a wide range of effects such as production of appropriate levels of light, darkness, and color within an image, such as alteration of hue, saturation, brightness or contrast of an image, such as production of blur, light bloom, volumetric lighting, normal mapping for depth effects, distortion, such as edge detection, motion detection, and many others). A GPU may thus execute a shader to transform two-dimensional or three-dimensional data into useful two-dimensional data for displaying.

Shaders may be written to apply transformations to a large set of elements at a time (e.g., to each pixel in an area of a screen, or for every vertex of a model). GPUs may thus execute shaders via parallel processing, and a GPU may have multiple shader pipelines (e.g., threads) to facilitate such parallel processing and improve computation throughput. Efficient compute operations may often rely on getting waves synchronized in a desired pattern. GPUs may implement systems of wave scheduling, however in some cases such scheduling may interfere with or contradict best execution for some types of workloads. In some cases, GPUs may handle non-uniform and irregular workloads for graphics, and current lock/barrier mechanisms may be deficient in achieving ideal synchronization patterns (e.g., lock/barrier mechanisms may force a wave to wait for others to catch up, which may result in processing delays). For example, in some cases, a shader structure may include loops, and subsequent loops (e.g., Wave0_loop1) may interrupt arithmetic logic unit (ALU) processing being done by an earlier loop (e.g., Wave2_loop0), which may result in processing interruptions (of Wave2_loop0).

According to the techniques described herein, a shader may control scheduling and prioritization of waves for improved synchronization patterns suited to various workloads (e.g., to prevent interference between waves and optimize GPU resource utilization for improved execution of various workload)s. For example, a GPU may execute a shader via multiple threads, and the shader may control scheduling and priority of waves executed via the multiple threads. As a thread is running, in addition to executing the instructions that the shader is telling it to do, the shader may also control (e.g., modify) priority dynamically. For example, if a GPU or shader finishes some critical section of a wave and wants to see to or execute other threads, the shader may decide to reduce the priority of the remainder of the wave (e.g., subsequent loops of the wave) such that other waves or tasks may be executed.

According to some aspects of the described techniques, instruction variants (e.g., set-lowest-priority, set-highest-priority, set-priority-to-N, etc.) may be executed by hardware during processing of a wave to control (e.g., modify) processing priority for that wave. As such, the described techniques for shader controlled wave scheduling priority may allow waves to be processed while avoiding interference with lagging waves, while avoiding taking resources from lagging waves, etc. In one example, when a set-lowest-priority instruction is executed by hardware during execution of a first loop of a first wave, the instruction may push the current wave's priority to be lowest on the list (e.g., in Eldest or Round-Robin priority schemes), raising the relative priority of all other waves. Such may result in other pending waves being processed prior to the processing returning to a second loop of the first wave. According to some aspects of the described techniques, priority assignment may be dynamic or not necessarily permanent (e.g., in Eldest/Round-Robin schemes, other waves may subsequently execute the set-lowest-priority instruction, such that the priority of the initial wave dynamically increases as subsequent waves are set to lowest priority). The described techniques may thus provide for shader priority control mechanisms, managed directly from software, which may improve GPU performance (e.g., improve GPU resource utilization, reduce parallel thread processing interruptions, improve wave synchronization, provide greater control for non-uniform or irregular workloads, etc.).

Aspects of the disclosure are initially described in the context of a multimedia system. Aspects of the disclosure are then described in the context of example devices and example processing diagrams. Aspects of the disclosure are further illustrated by and described with reference to apparatus diagrams, system diagrams, and flowcharts that relate to shader controlled wave scheduling priority.

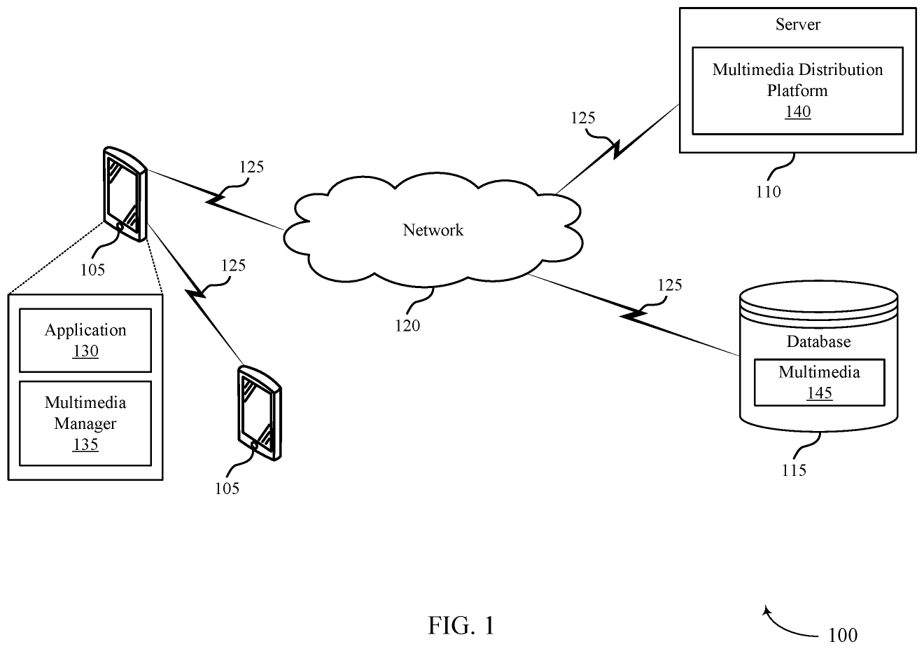

FIG. 1 illustrates a multimedia system 100 for a device that supports shader controlled wave scheduling priority in accordance with one or more aspects of the present disclosure. The multimedia system 100 may include devices 105, a server 110, and a database 115. Although, the multimedia system 100 illustrates two devices 105, a single server 110, a single database 115, and a single network 120, the present disclosure applies to any multimedia system architecture having one or more devices 105, servers 110, databases 115, and networks 120. The devices 105, the server 110, and the database 115 may communicate with each other and exchange information that supports shader controlled wave scheduling priority, such as multimedia packets, multimedia data, or multimedia control information, via network 120 using communications links 125. In some cases, a portion or all of the techniques described herein supporting shader controlled wave scheduling priority may be performed by the devices 105 or the server 110, or both.

A device 105 may be a cellular phone, a smartphone, a personal digital assistant (PDA), a wireless communication device, a handheld device, a tablet computer, a laptop computer, a cordless phone, a display device (e.g., monitors), and/or the like that supports various types of communication and functional features related to multimedia (e.g., transmitting, receiving, broadcasting, streaming, sinking, capturing, storing, and recording multimedia data). A device 105 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 105 may also be able to communicate directly with another device (e.g., using a peer-to-peer (P2P) or device-to-device (D2D) protocol). For example, a device 105 may be able to receive from or transmit to another device 105 variety of information, such as instructions or commands (e.g., multimedia-related information).

The devices 105 may include an application 130 and a multimedia manager 135. While, the multimedia system 100 illustrates the devices 105 including both the application 130 and the multimedia manager 135, the application 130 and the multimedia manager 135 may be an optional feature for the devices 105. In some cases, the application 130 may be a multimedia-based application that can receive (e.g., download, stream, broadcast) from the server 110, database 115 or another device 105, or transmit (e.g., upload) multimedia data to the server 110, the database 115, or to another device 105 via using communications links 125.

The multimedia manager 135 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 135 may process multimedia (e.g., image data, video data, audio data) from and/or write multimedia data to a local memory of the device 105 or to the database 115.

The multimedia manager 135 may also be configured to provide multimedia enhancements, multimedia restoration, multimedia analysis, multimedia compression, multimedia streaming, and multimedia synthesis, among other functionality. For example, the multimedia manager 135 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 135 may process multimedia data to support shader controlled wave scheduling priority, according to the techniques described herein.

The server 110 may be a data server, a cloud server, a server associated with an multimedia subscription provider, proxy server, web server, application server, communications server, home server, mobile server, or any combination thereof. The server 110 may in some cases include a multimedia distribution platform 140. The multimedia distribution platform 140 may allow the devices 105 to discover, browse, share, and download multimedia via network 120 using communications links 125, and therefore provide a digital distribution of the multimedia from the multimedia distribution platform 140. As such, a digital distribution may be a form of delivering media content such as audio, video, images, without the use of physical media but over online delivery mediums, such as the Internet. For example, the devices 105 may upload or download multimedia-related applications for streaming, downloading, uploading, processing, enhancing, etc. multimedia (e.g., images, audio, video). The server 110 may also transmit to the devices 105 a variety of information, such as instructions or commands (e.g., multimedia-related information) to download multimedia-related applications on the device 105.

The database 115 may store a variety of information, such as instructions or commands (e.g., multimedia-related information). For example, the database 115 may store multimedia 145. The device may support shader controlled wave scheduling priority associated with the multimedia 145. The device 105 may retrieve the stored data from the database 115 via the network 120 using communications links 125. In some examples, the database 115 may be a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 120 may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 120 may include the Internet.

The communications links 125 shown in the multimedia system 100 may include uplink transmissions from the device 105 to the server 110 and the database 115, and/or downlink transmissions, from the server 110 and the database 115 to the device 105. The communications links 125 may transmit bidirectional communications and/or unidirectional communications. In some examples, the communications links 125 may be a wired connection or a wireless connection, or both. For example, the communications links 125 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

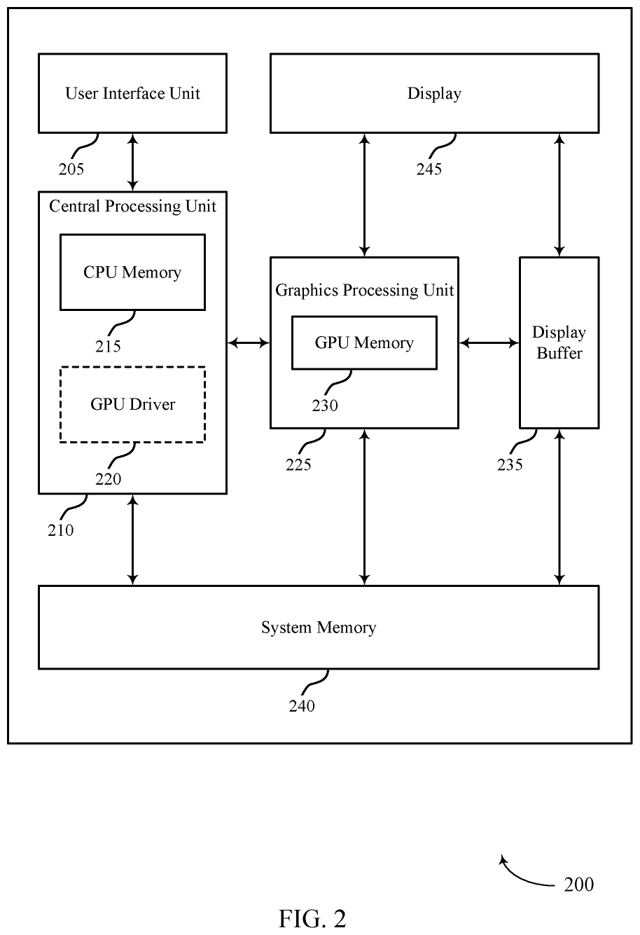

A device 105 (e.g., which may be an example of a device 200 described with reference to FIG. 2) may implement techniques for shader controlled wave scheduling priority, as described herein. For example, a device 105 may include a GPU, and may execute shader (e.g., shader programs) that implement techniques for shader controlled wave scheduling priority. In some cases, such techniques may improve GPU operation, and thus may improve overall device 105 operation. For example, the described techniques may enhance the multimedia capabilities of the device 105, may reduce latency of the device 105 in performing multimedia operations (e.g., such as graphic generation and graphic display), etc.

FIG. 2 illustrates an example of a device 200 that supports shader controlled wave scheduling priority in accordance with one or more aspects of the present disclosure. In some examples, device 200 may implement aspects of shader controlled wave scheduling priority performed by a device 105 as described with reference to FIG. 1. Examples of device 200 include, but are not limited to, wireless devices, mobile or cellular telephones, including smartphones, personal digital assistants (PDAs), video gaming consoles that include video displays, mobile video gaming devices, mobile video conferencing units, laptop computers, desktop computers, televisions set-top boxes, tablet computing devices, e-book readers, fixed or mobile media players, and the like.

In the example of FIG. 2, device 200 includes a central processing unit (CPU) 210 having CPU memory 215, a GPU 225 having GPU memory 230, a display 245, a display buffer 235 storing data associated with rendering, a user interface unit 205, and a system memory 240. For example, system memory 240 may store a GPU driver 220 (illustrated as being contained within CPU 210 as described below) having a compiler, a GPU program, a locally-compiled GPU program, and the like. User interface unit 205, CPU 210, GPU 225, system memory 240, and display 245 may communicate with each other (e.g., using a system bus).

Examples of CPU 210 include, but are not limited to, a DSP, general purpose microprocessor, ASIC, FPGA, or other equivalent integrated or discrete logic circuitry. Although CPU 210 and GPU 225 are illustrated as separate units in the example of FIG. 2, in some examples, CPU 210 and GPU 225 may be integrated into a single unit. CPU 210 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 245. As illustrated, CPU 210 may include CPU memory 215. For example, CPU memory 215 may represent on-chip storage or memory used in executing machine or object code. CPU memory 215 may include one or more volatile or non-volatile memories or storage devices, such as flash memory, a magnetic data media, an optical storage media, etc. CPU 210 may be able to read values from or write values to CPU memory 215 more quickly than reading values from or writing values to system memory 240, which may be accessed, e.g., over a system bus.

GPU 225 may represent one or more dedicated processors for performing graphical operations. That is, for example, GPU 225 may be a dedicated hardware unit having fixed function and programmable components for rendering graphics and executing GPU applications. GPU 225 may also include a DSP, a general purpose microprocessor, an ASIC, an FPGA, or other equivalent integrated or discrete logic circuitry. GPU 225 may be built with a highly-parallel structure that provides more efficient processing of complex graphic-related operations than CPU 210. For example, GPU 225 may include a plurality of processing elements that are configured to operate on multiple vertices or pixels in a parallel manner. The highly parallel nature of GPU 225 may allow GPU 225 to generate graphic images (e.g., graphical user interfaces and two-dimensional or three-dimensional graphics scenes) for display 245 more quickly than CPU 210.

GPU 225 may, in some instances, be integrated into a motherboard of device 200. In other instances, GPU 225 may be present on a graphics card that is installed in a port in the motherboard of device 200 or may be otherwise incorporated within a peripheral device configured to interoperate with device 200. As illustrated, GPU 225 may include GPU memory 230. For example, GPU memory 230 may represent on-chip storage or memory used in executing machine or object code. GPU memory 230 may include one or more volatile or non-volatile memories or storage devices, such as flash memory, a magnetic data media, an optical storage media, etc. GPU 225 may be able to read values from or write values to GPU memory 230 more quickly than reading values from or writing values to system memory 240, which may be accessed, e.g., over a system bus. That is, GPU 225 may read data from and write data to GPU memory 230 without using the system bus to access off-chip memory. This operation may allow GPU 225 to operate in a more efficient manner by reducing the need for GPU 225 to read and write data via the system bus, which may experience heavy bus traffic.

Display 245 represents a unit capable of displaying video, images, text or any other type of data for consumption by a viewer. Display 245 may include a liquid-crystal display (LCD), a light emitting diode (LED) display, an organic LED (OLED), an active-matrix OLED (AMOLED), or the like. Display buffer 235 represents a memory or storage device dedicated to storing data for presentation of imagery, such as computer-generated graphics, still images, video frames, or the like for display 245. Display buffer 235 may represent a two-dimensional buffer that includes a plurality of storage locations. The number of storage locations within display buffer 235 may, in some cases, generally correspond to the number of pixels to be displayed on display 245. For example, if display 245 is configured to include 640×480 pixels, display buffer 235 may include 640×480 storage locations storing pixel color and intensity information, such as red, green, and blue pixel values, or other color values. Display buffer 235 may store the final pixel values for each of the pixels processed by GPU 225. Display 245 may retrieve the final pixel values from display buffer 235 and display the final image based on the pixel values stored in display buffer 235.

User interface unit 205 represents a unit with which a user may interact with or otherwise interface to communicate with other units of device 200, such as CPU 210. Examples of user interface unit 205 include, but are not limited to, a trackball, a mouse, a keyboard, and other types of input devices. User interface unit 205 may also be, or include, a touch screen and the touch screen may be incorporated as part of display 245.

System memory 240 may comprise one or more computer-readable storage media. Examples of system memory 240 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 240 may store program modules and/or instructions that are accessible for execution by CPU 210. Additionally, system memory 240 may store user applications and application surface data associated with the applications. System memory 240 may in some cases store information for use by and/or information generated by other components of device 200. For example, system memory 240 may act as a device memory for GPU 225 and may store data to be operated on by GPU 225 as well as data resulting from operations performed by GPU 225

In some examples, system memory 240 may include instructions that cause CPU 210 or GPU 225 to perform the functions ascribed to CPU 210 or GPU 225 in aspects of the present disclosure. System memory 240 may, in some examples, be considered as a non-transitory storage medium. The term “non-transitory” should not be interpreted to mean that system memory 240 is non-movable. As one example, system memory 240 may be removed from device 200 and moved to another device. As another example, a system memory substantially similar to system memory 240 may be inserted into device 200. In certain examples, a non-transitory storage medium may store data that can, over time, change (e.g., in RAM).

System memory 240 may store a GPU driver 220 and compiler, a GPU program, and a locally-compiled GPU program. The GPU driver 220 may represent a computer program or executable code that provides an interface to access GPU 225. CPU 210 may execute the GPU driver 220 or portions thereof to interface with GPU 225 and, for this reason, GPU driver 220 is shown in the example of FIG. 2 within CPU 210. GPU driver 220 may be accessible to programs or other executables executed by CPU 210, including the GPU program stored in system memory 240. Thus, when one of the software applications executing on CPU 210 requires graphics processing, CPU 210 may provide graphics commands and graphics data to GPU 225 for rendering to display 245 (e.g., via GPU driver 220).

In some cases, the GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of a GPU 225 to execute commands without user knowledge as to the specifics of the hardware components. In order to process the graphics rendering instructions, CPU 210 may issue one or more rendering commands to GPU 225 (e.g., through GPU driver 220) to cause GPU 225 to perform some or all of the rendering of the graphics data. In some examples, the graphics data to be rendered may include a list of graphics primitives (e.g., points, lines, triangles, quadrilaterals, etc.).

The GPU program stored in system memory 240 may invoke or otherwise include one or more functions provided by GPU driver 220. CPU 210 generally executes the program in which the GPU program is embedded and, upon encountering the GPU program, passes the GPU program to GPU driver 220. CPU 210 executes GPU driver 220 in this context to process the GPU program. That is, for example, GPU driver 220 may process the GPU program by compiling the GPU program into object or machine code executable by GPU 225. This object code may be referred to as a locally-compiled GPU program. In some examples, a compiler associated with GPU driver 220 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions may be capable of being executed by specific types of processors or other types of hardware, such as FPGAs, ASICs, and the like (including, but not limited to, CPU 210 and GPU 225).

In the example of FIG. 2, in some cases, the compiler may receive a GPU program (e.g., a shader, a shader program, etc.) from CPU 210. That is, a software application being executed by CPU 210 may invoke GPU driver 220 (e.g., via a graphics API) to issue one or more commands to GPU 225 for execution of the shader. The compiler may compile the shader to generate the locally-compiled shader. The compiler may then output the locally-compiled shader that includes some set of instruction. In some examples, the shader may include data loads (ld), a long sync (sy), and a set of ALU operations (alu).

According to the techniques described herein, a shader may control scheduling and prioritization of waves to prevent interference between waves and optimize GPU 225 resource utilization for improved execution of various workloads. For example, a GPU 225 may execute a shader via multiple threads, and the shader may control scheduling and priority of waves executed via the multiple threads. As a thread is running, in addition to executing the instructions that the shader is telling it to do, the shader may also control (e.g., modify) priority dynamically. For example, if a GPU 225 or shader finishes some critical section of a wave and wants to see to or execute other threads, the shader may decide to reduce the priority of the remainder of the wave (e.g., additional loops of the wave) such that other waves or tasks may be executed.

In some cases, a GPU 225 may handle non-uniform and irregular workloads for graphics. As such, a GPU 225 may have systems for wave scheduling to increase performance of irregular workload processing. However, as discussed, in some cases these systems for scheduling waves may interfere with best execution for certain types of workloads. The techniques for shader controlled wave scheduling priority described herein may consider the application when prioritizing and scheduling waves for processing by the GPU 225. A shader may control scheduling and prioritization of waves to prevent interference between waves and optimize GPU 225 resource utilization. In some cases, a wave may refer to a hardware thread (e.g., which may work on a vector) where all waves collectively execute a same shader (e.g., a same program). For example, a wave may issue a load request and wait for the request to be completed. The shader may include instructions for how waves may be prioritized and scheduled in order to optimize GPU 225 execution of the shader program, to more efficiently utilize resources (e.g., ALU resources) of the GPU 225, etc.

As such, a GPU 225 may execute multiple threads of a shader program, process instructions within each thread, and identify priority or scheduling of waves executed by the various threads respect to other waves or other threads (e.g., such that a shader may control priority of waves within a work group). In other words, a shader may refer to a program or a set of instructions to process one or more waves, and the waves may be assigned to processor threads of a GPU 225. The techniques described herein may provide for a mechanism for a shader to modify the priority of each thread. As a thread is running, in addition to executing the instructions that the shader is telling the GPU 225 to perform, the shader may define priority of the wave being processed at any time. For example, if a GPU 225 finishes some critical section of a wave, a shader may alter the priority of the wave to allow the GPU 225 to use resources on other threads or on other waves. The techniques described herein may generally be applied using various APIs, which in some cases may use different programming terminology than used throughout the specification.

In some cases, the shader instructions (e.g., which may be referred to as a hardware priority control instruction, an instruction variant, etc.) priority assignment may not be permanent, as when the shader instructions continue to execute the relative priority of the waves (or threads) may dynamically change. For example, in an Eldest scheme if other waves subsequently execute a set-lowest-priority instruction, the priority of the initial wave will gradually increase again. In the Round-Robin scheme, the wave will eventually rise to the top of priority in response to other waves executing and having the priority rotate.

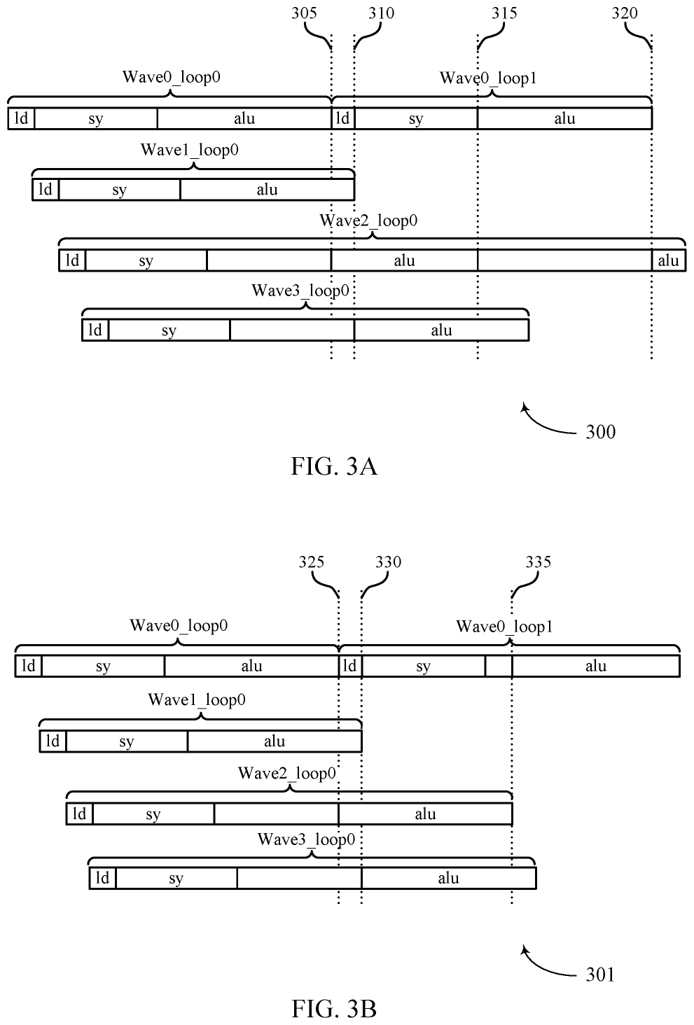

FIGS. 3A and 3B illustrate examples of processing diagrams that support shader controlled wave scheduling priority in accordance with one or more aspects of the present disclosure. FIG. 3A may illustrate an example processing diagram 300 and FIG. 3B may illustrate an example processing diagram 301. In some examples, multimedia system 100 and/or device 200 may implement aspects of processing diagram 300 and/or processing diagram 301. Processing diagram 300 and processing diagram 301 may illustrate aspects of GPU parallel processing. For example processing diagram 300 and processing diagram 301 may illustrate GPU execution of a shader using four threads, where the GPU has a capability of processing two ALUs in parallel (e.g., the GPU has two arithmetic logic unit processing resources).

For example, each thread may be some sequence of instructions, and a GPU may have multiple threads processing in parallel. In such examples, different waves may be distributed to different threads to balance the parallel processing (e.g., and together the threads make up the execution of the shader). As discussed herein, in some cases, efficient compute operations may rely on getting waves synchronized in a desired pattern. While some various lock/sync/barrier mechanisms can do this, they often don't do it in the most efficient manner. For instance, in the example of FIG. 3A, shader execution via conventional lock/barrier sync mechanisms may force a wave to wait for others to catch up.

Example processing diagram 300 may illustrate a scenario where shader execution may result in a wave (e.g., Wave2_loop0) being forced to wait for other waves (e.g., Wave0_loop1) to catch up. For example, an example shader may include data loads (ld), a long sync (sy), and a set of ALU operations (ALU). Given waves 0-3 (e.g., Wave0_loop0, Wave1_loop0, Wave2_loop0, and Wave3_loop0), with Eldest priority, and two available ALU resources, processing diagram 300 may illustrate a shader execution diagram with four active waves. As discussed herein, two available ALU resources may refer to a GPU capability to process or perform two ALU operations in parallel. In the present example, a first ALU operation associated with Wave0_loop0 and a second ALU operation associated with Wave1_loop0 may be processed or performed in parallel via first and second threads of the shader. At 305, the first ALU operation associated with Wave0_loop0 may be completed (e.g., processed) and thus processing of a third ALU operation associated with Wave2_loop0 may be initiated. Similarly, at 310, the second ALU operation associated with Wave1_loop0 may be completed (e.g., processed) and thus processing of a fourth ALU operation associated with Wave3_loop0 may be initiated.

However, in the example of FIG. 3A, addition of a fifth wave (e.g., a Wave4) may result in Wave0_loop1 interrupts the ALU work being done by Wave2, since Wave0 is eldest. For example, in examples where a shader implements a loop, what may happen is that Wave0_loop1 may interrupt the ALU work being done by Wave2, since Wave0 is eldest. For example a shader structure may include:

For loop=0 . . . N
ld
sy
alu

In some cases, it may be desirable for the wave execution behavior to treat the second loop of each wave as lower priority than the first loop (treating the second loop as if it were a new wave, priority-wise). That is, for improved GPU operation (e.g., for some workloads), addition of a fifth wave where older Wave2 gets to finish its ALU work before the newer Wave4 gets to do its own may be desirable.

That is, it may be more efficient to allow such a wave to do what it can, while avoid interfering or taking resources from the lagging waves. The techniques described herein provide for the concept of shader-controlled wave scheduling priority. Instruction variants can be relative to other waves such as, set-lowest-priority, set-highest-priority, lower-priority-by-N, raise-priority-by-N, or absolute, such as set-priority-to-N. For instance, when the set-lowest-priority instruction is executed by hardware, the instruction may push the current wave's priority to be lowest on the list (e.g., either in ‘Eldest’ or ‘Round-Robin’ priority schemes), raising the relative priority of all other waves. This priority assignment may be dynamic (e.g., not necessarily permanent). In the Eldest scheme, if other waves subsequently execute the set-lowest-priority instruction, the priority of the initial wave may gradually increase again. In the Round-Robin scheme, the wave may eventually rise to the top of priority in response to other waves executing and having the priority rotate.

In the example of FIG. 3B, processing diagram 301 may illustrate an example where the wave execution behavior to treat the second loop of each wave as lower priority than the first loop (treating the second loop as if it were a new wave, priority-wise). For example, a set-lowest-priority instruction may be implemented for shader controlled wave scheduling priority techniques described herein. For instance, a shader structure may include:

For loop=0 . . . N
ld
set-lowest-priority
sy
alu
   As such, in the example of FIG. 3B, a first ALU operation associated with Wave0_loop0 and a second ALU operation associated with Wave1_loop0 may be processed or performed in parallel via first and second threads of the shader. At 325, the first ALU operation associated with Wave0_loop0 may be completed (e.g., processed) and thus processing of a third ALU operation associated with Wave2_loop0 may be initiated. Similarly, at 330, the second ALU operation associated with Wave1_loop0 may be completed (e.g., processed) and thus processing of a fourth ALU operation associated with Wave3_loop0 may be initiated. According to the techniques described herein, a fifth wave (e.g., Wave0_loop1 in the present example) may issue a load request (ld) at 325 (e.g., upon completion of the first ALU operation associated with Wave0_loop0) and the shader may control wave scheduling priority such that the ALU operation associated with the fifth wave may wait until the Wave2_loop0 wave completes its associated ALU operation at 335.

That is, a shader may control wave scheduling priority such that the first loop of Wave0 (e.g., Wave0_loop0) may be executed, and the shader may include a set-lowest-priority such that subsequent loops of Wave0 are set to a lowest priority (e.g., such that Wave2_loop0 has a higher priority for ALU operation completion than Wave0_loop1). As such, Wave2 processing may not be interrupted by Wave0_loop1 processing which, in some cases, may provide for improved execution for some GPU workloads. In some cases, a similar execution order may have been achieved with a barrier instruction, however such an approach may result in longer execution time since all waves would be stalled at each loop iteration.

A shader may implement one or more aspects of the shader controlled wave scheduling priority techniques described herein to allow or prevent interference or interruption between waves (e.g., which may optimize how resources, such as GPU ALU processing resources, are used for improved GPU performance in handling various workloads). In some cases, the proposed control mechanism (e.g., shader controlled wave scheduling priority) may be managed directly from software. Generally, a shader may implement one or more aspects of the shader controlled wave scheduling priority techniques described herein for various applications and workloads by analogy, without departing from the scope of the present disclosure. For example, the described techniques may apply to various GPUs (e.g., GPUs with various ALU processing resources/capabilities), various number of threads, various numbers of waves, various shader structures (e.g., shader structures with or without loops), etc., as would be well understood by one of skill in the art. As discussed herein, a shader may employ various instruction variants to control wave scheduling priority. For example, a shader may employ other instruction variants to control wave scheduling priority in a different manner than in the example of FIG. 3B (e.g., where the shader may set loops of a Wave0 that are subsequent to an initial loop of a Wave0 to a lowest priority).

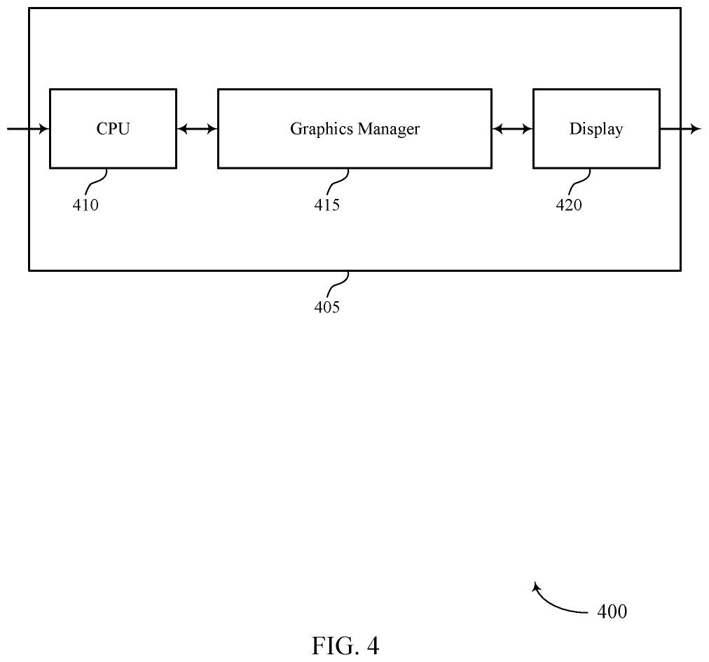

FIG. 4 shows a block diagram 400 of a device 405 that supports shader controlled wave scheduling priority in accordance with one or more aspects of the present disclosure. The device 405 may be an example of aspects of a device 105 or a device 200 as described herein. The device 405 may include a CPU 410, a graphics manager 415, and a display 420. The device 405 may also include a general processor. Each of these components may be in communication with one another (e.g., via one or more buses).

CPU 410 may be an example of CPU 210 described with reference to FIG. 2. CPU 410 may execute one or more software applications, such as web browsers, graphical user interfaces, video games, or other applications involving graphics rendering for image depiction (e.g., via display 420). As described above, CPU 410 may encounter a GPU program (e.g., a program suited for handling by a GPU or graphics manager 415) when executing the one or more software applications. Accordingly, CPU 410 may submit rendering commands to graphics manager 415 (e.g., via a GPU driver containing a compiler for parsing API-based commands).

The graphics manager 415 may identify a set of threads of a graphics processing unit for executing a program, where each thread is associated with a priority, modify the priority of the first thread relative to a remainder of the set of threads based on beginning processing of the first thread, begin processing of a first thread of the set of threads based on the identified set of threads and the priority, and process the remainder of the set of threads and a remainder of the first thread based on the modified priority. The graphics manager 415 may be an example of aspects of the GPU 225 or a graphics manager 710 described herein. The operations performed by graphics manager 415 may improve device 405 (e.g., GPU) performance, improve device 405 utilization of GPU resources (e.g., ALU resources), reduce parallel thread processing interruptions, improve wave synchronization, provide greater control for non-uniform or irregular workloads, etc.

The graphics manager 415, or its sub-components, may be implemented in hardware, code (e.g., software or firmware) executed by a processor, or any combination thereof. If implemented in code executed by a processor, the functions of the graphics manager 415, or its sub-components may be executed by a general-purpose processor, a DSP, an ASIC, a FPGA or other programmable logic device, discrete gate or transistor logic, discrete hardware components, or any combination thereof designed to perform the functions described in the present disclosure.

The graphics manager 415, or its sub-components, may be physically located at various positions, including being distributed such that portions of functions are implemented at different physical locations by one or more physical components. In some examples, the graphics manager 415, or its sub-components, may be a separate and distinct component in accordance with various aspects of the present disclosure. In some examples, the graphics manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

Display 420 may display content generated by other components of the device. Display 420 may be an example of display 245 as described with reference to FIG. 2. In some examples, display 420 may be connected with a display buffer which stores rendered data until an image is ready to be displayed (e.g., as described with reference to FIG. 2).

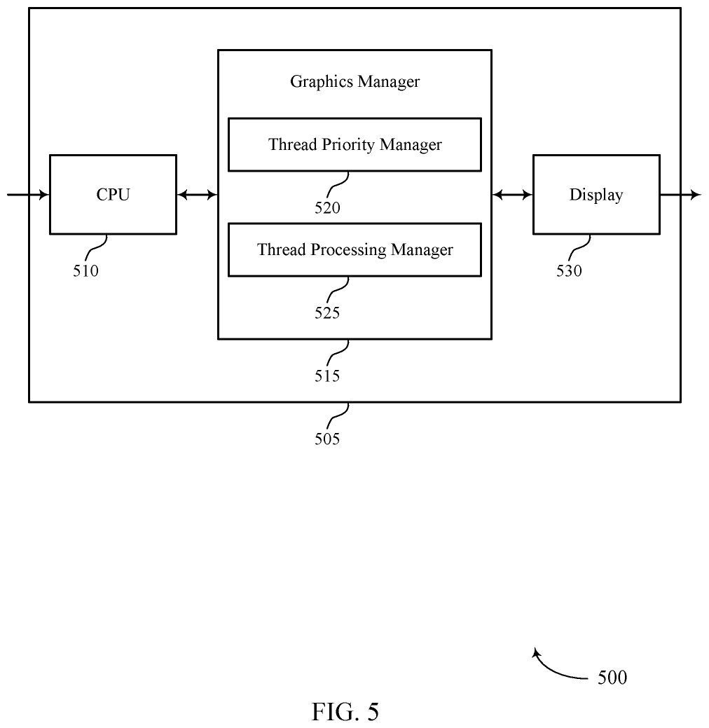

FIG. 5 shows a block diagram 500 of a device 505 that supports shader controlled wave scheduling priority in accordance with one or more aspects of the present disclosure. The device 505 may be an example of aspects of a device 405, a device 105, or a device 200 as described herein. The device 505 may include a CPU 510, a graphics manager 515, and a display 530. The device 505 may also include a processor. Each of these components may be in communication with one another (e.g., via one or more buses).

CPU 510 may be an example of CPU 210 described with reference to FIG. 2. CPU 510 may execute one or more software applications, such as web browsers, graphical user interfaces, video games, or other applications involving graphics rendering for image depiction (e.g., via display 530). As described above, CPU 510 may encounter a GPU program (e.g., a program suited for handling by a GPU or graphics manager 515) when executing the one or more software applications. Accordingly, CPU 510 may submit rendering commands to graphics manager 515 (e.g., via a GPU driver containing a compiler for parsing API-based commands).

The graphics manager 515 may be an example of aspects of the graphics manager 415 or a GPU 225 as described herein. The graphics manager 515 may include a thread priority manager 520 and a thread processing manager 525. The graphics manager 515 may be an example of aspects of the graphics manager 710 described herein.

The thread priority manager 520 may identify a set of threads of a graphics processing unit for executing a program, where each thread is associated with a priority. The thread priority manager 520 may modify the priority of the first thread relative to a remainder of the set of threads based on beginning processing of the first thread. The operations performed by the thread priority manager 520 may improve device 505 utilization of GPU resources (e.g., ALU resources), reduce parallel thread processing interruptions by thread processing manager 525, improve wave synchronization by thread processing manager 525, provide greater control for non-uniform or irregular workloads, etc. The thread processing manager 525 may begin processing of a first thread of the set of threads based on the identified set of threads and the priority, and thread processing manager 525 may process the remainder of the set of threads and a remainder of the first thread based on the modified priority.

Display 530 may display content generated by other components of the device. Display 530 may be an example of display 245 as described with reference to FIG. 2 or a display 420 as described with reference to FIG. 4. In some examples, display 530 may be connected with a display buffer which stores rendered data until an image is ready to be displayed (e.g., as described with reference to FIG. 2).

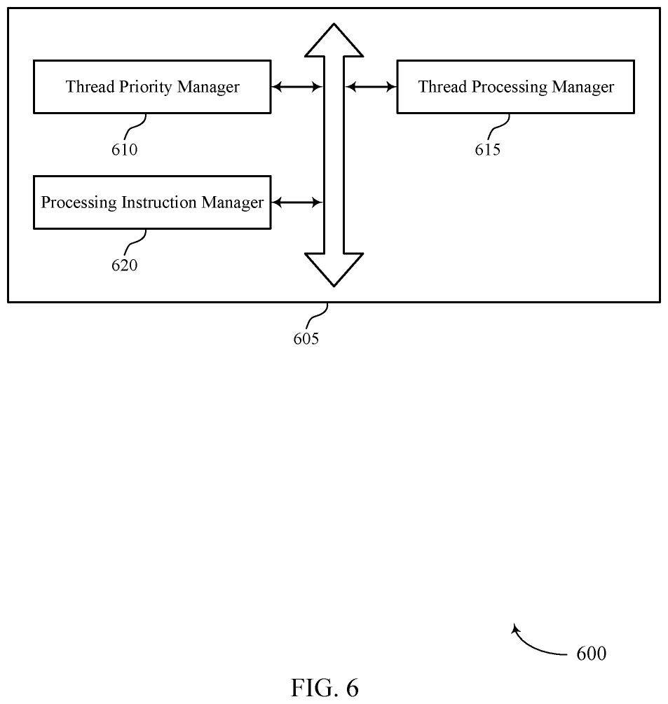

FIG. 6 shows a block diagram 600 of a graphics manager 605 that supports shader controlled wave scheduling priority in accordance with one or more aspects of the present disclosure. The graphics manager 605 may be an example of aspects of a graphics manager 415, a graphics manager 515, or a graphics manager 710 described herein. The graphics manager 605 may include a thread priority manager 610, a thread processing manager 615, and a processing instruction manager 620. Each of these modules may communicate, directly or indirectly, with one another (e.g., via one or more buses).

The thread priority manager 610 may identify a set of threads of a graphics processing unit for executing a program, where each thread is associated with a priority. In some examples, the thread priority manager 610 may modify the priority of the first thread relative to a remainder of the set of threads based on beginning processing of the first thread. In some examples, the thread priority manager 610 may modify the priority of at least one thread of the remainder of the set of threads relative to the first thread based on processing the first portion of each thread of the remainder of the set of threads, where the remainder of the first thread is processed based on the modified priority of the at least one thread of the remainder of the set of threads.

The thread processing manager 615 may begin processing of a first thread of the set of threads based on the identified set of threads and the priority. In some examples, the thread processing manager 615 may process the remainder of the set of threads and a remainder of the first thread based on the modified priority. In some examples, the thread processing manager 615 may process a first portion of the first thread based on beginning processing of the first thread, where the priority of the first thread relative to the remainder of the set of threads is modified based on processing the first portion of the first thread. In some examples, the thread processing manager 615 may process a first portion of each thread of the remainder of the set of threads.

In some examples, the thread processing manager 615 may process the remainder of the first thread based on processing the first portion of each thread of the remainder of the set of threads. In some examples, the thread processing manager 615 may process a first arithmetic logic unit operation associated with a second thread of the remainder of the set of threads. In some examples, the thread processing manager 615 may process a second arithmetic logic unit operation associated with the remainder of the first thread based on processing the first arithmetic logic unit operation associated with the second thread. In some cases, the first portion of the first thread includes a first loop of a load operation, a long sync operation, and an arithmetic logic unit operation, and the remainder of the first thread includes one or more loops other than the first loop.

The processing instruction manager 620 may determine one or more operations of the remainder of the set of threads is of higher priority than the remainder of the first thread, where the priority of the first thread relative to the remainder of the set of threads is modified based on the determination. In some examples, the processing instruction manager 620 may process a hardware priority control instruction within the program for the first thread that indicates the priority of the remainder of the first thread relative to the remainder of the set of threads. In some cases, a set-lowest-priority instruction, a set-highest-priority instruction, a lower-priority-by-N instruction, a raise-priority-by-N instruction, and a set-priority-to-N instruction. In some cases, the priority of the remainder of the first thread relative to the remainder of the set of threads is modified based on a number of available arithmetic logic unit resources or a number of threads in the set of threads of the graphics processing unit.

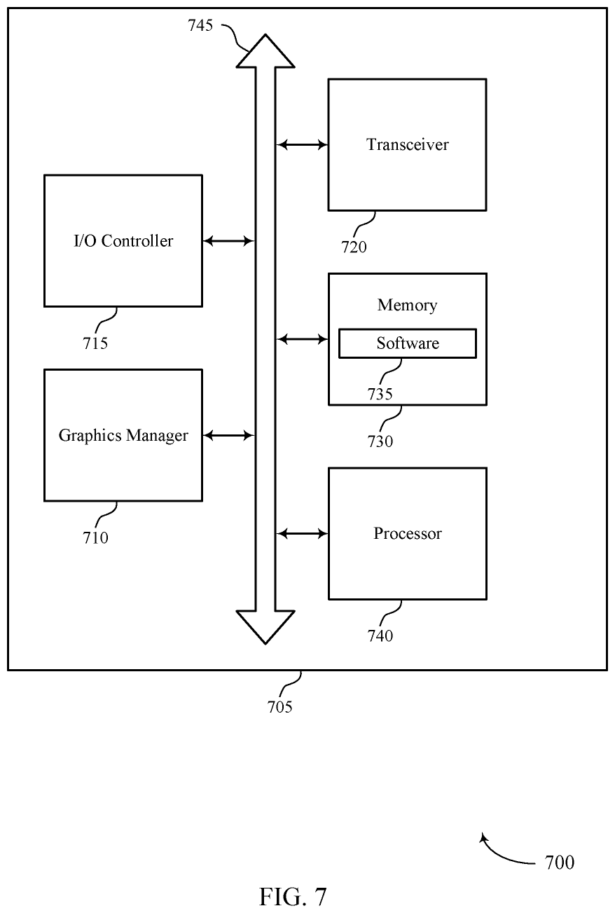

FIG. 7 shows a diagram of a system 700 including a device 705 that supports shader controlled wave scheduling priority in accordance with one or more aspects of the present disclosure. The device 705 may be an example of or include the components of device 405, device 505, device 105, or device 200 as described herein. The device 705 may include components for bi-directional voice and data communications including components for transmitting and receiving communications, including a graphics manager 710, an I/O controller 715, a transceiver 720, an antenna 725, memory 730, a processor 740, and a coding manager 750. These components may be in electronic communication via one or more buses (e.g., bus 745).

The graphics manager 710 may identify a set of threads of a graphics processing unit for executing a program, where each thread is associated with a priority, modify the priority of the first thread relative to a remainder of the set of threads based on beginning processing of the first thread, begin processing of a first thread of the set of threads based on the identified set of threads and the priority, and process the remainder of the set of threads and a remainder of the first thread based on the modified priority. As discussed herein, in some cases, the graphics manager 710 may be an example of aspects of a GPU.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

The memory 730 may include RAM and ROM. The memory 730 may store computer-readable, computer-executable code or software 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting shader controlled wave scheduling priority). In some cases, processor 740 may be an example of aspects of a CPU described herein.

The software 735 may include instructions to implement aspects of the present disclosure, including instructions to support graphics processing. The software 735 may be stored in a non-transitory computer-readable medium such as system memory or other type of memory. In some cases, the software 735 may not be directly executable by the processor 740 but may cause a computer (e.g., when compiled and executed) to perform functions described herein.

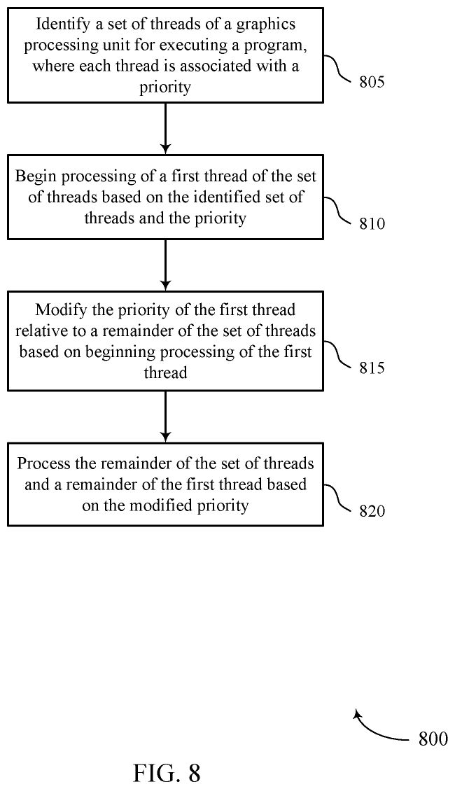

FIG. 8 shows a flowchart illustrating a method 800 that supports shader controlled wave scheduling priority in accordance with one or more aspects of the present disclosure. The operations of method 800 may be implemented by a device or its components as described herein. For example, the operations of method 800 may be performed by a graphics manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 805, the device may identify a set of threads of a graphics processing unit for executing a program, where each thread is associated with a priority. The operations of 805 may be performed according to the methods described herein. In some examples, aspects of the operations of 805 may be performed by a thread priority manager as described with reference to FIGS. 4 through 7.

At 810, the device may begin processing of a first thread of the set of threads based on the identified set of threads and the priority. The operations of 810 may be performed according to the methods described herein. In some examples, aspects of the operations of 810 may be performed by a thread processing manager as described with reference to FIGS. 4 through 7.

At 815, the device may modify the priority of the first thread relative to a remainder of the set of threads based on beginning processing of the first thread. In other words, a shader may control wave priority based on processing some critical section, an initial wave, first loop iteration, etc. of the first thread. The operations of 815 may be performed according to the methods described herein. In some examples, aspects of the operations of 815 may be performed by a thread priority manager as described with reference to FIGS. 4 through 7.

At 820, the device may process the remainder of the set of threads and a remainder of the first thread based on the modified priority. The operations of 820 may be performed according to the methods described herein. In some examples, aspects of the operations of 820 may be performed by a thread processing manager as described with reference to FIGS. 4 through 7.

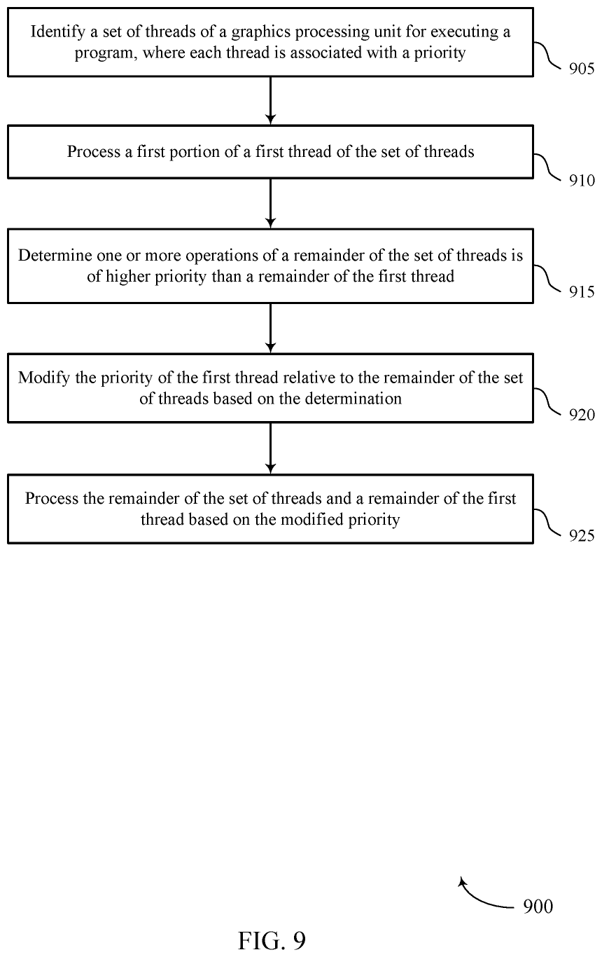

FIG. 9 shows a flowchart illustrating a method 900 that supports shader controlled wave scheduling priority in accordance with one or more aspects of the present disclosure. The operations of method 900 may be implemented by a device or its components as described herein. For example, the operations of method 900 may be performed by a graphics manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 905, the device may identify a set of threads of a graphics processing unit for executing a program, where each thread is associated with a priority. The operations of 905 may be performed according to the methods described herein. In some examples, aspects of the operations of 905 may be performed by a thread priority manager as described with reference to FIGS. 4 through 7.

At 910, the device may process a first portion of a first thread (e.g., a first thread of the set of threads). The operations of 910 may be performed according to the methods described herein. In some examples, aspects of the operations of 910 may be performed by a thread processing manager as described with reference to FIGS. 4 through 7.

At 915, the device may determine one or more operations of a remainder of the set of threads (e.g., remaining threads of the set of threads, other than the first thread) is of higher priority than a remainder of the first thread (e.g., based on processing the first portion of the first thread). For example, a shader may control wave scheduling priority such that after the device processes the first portion of the first thread, the shader may include an instruction controlling the priority of the remainder of the first thread (e.g., additional loops of a wave processed via the first thread) relative to the one or more operations of the remainder of the set of threads (e.g., relative to other threads or other waves). The operations of 915 may be performed according to the methods described herein. In some examples, aspects of the operations of 915 may be performed by a processing instruction manager as described with reference to FIGS. 4 through 7.

At 920, the device may modify the priority of the first thread (e.g., the priority of the remainder of the first thread) relative to the remainder of the set of threads based on the determination that one or more operations of the remainder of the set of threads is of higher priority than the remainder of the first thread (e.g., based on shader control or shader instruction regarding wave scheduling priority). The operations of 920 may be performed according to the methods described herein. In some examples, aspects of the operations of 920 may be performed by a thread priority manager as described with reference to FIGS. 4 through 7.

At 925, the device may process the remainder of the set of threads and the remainder of the first thread based on the modified priority. The operations of 925 may be performed according to the methods described herein. In some examples, aspects of the operations of 925 may be performed by a thread processing manager as described with reference to FIGS. 4 through 7.

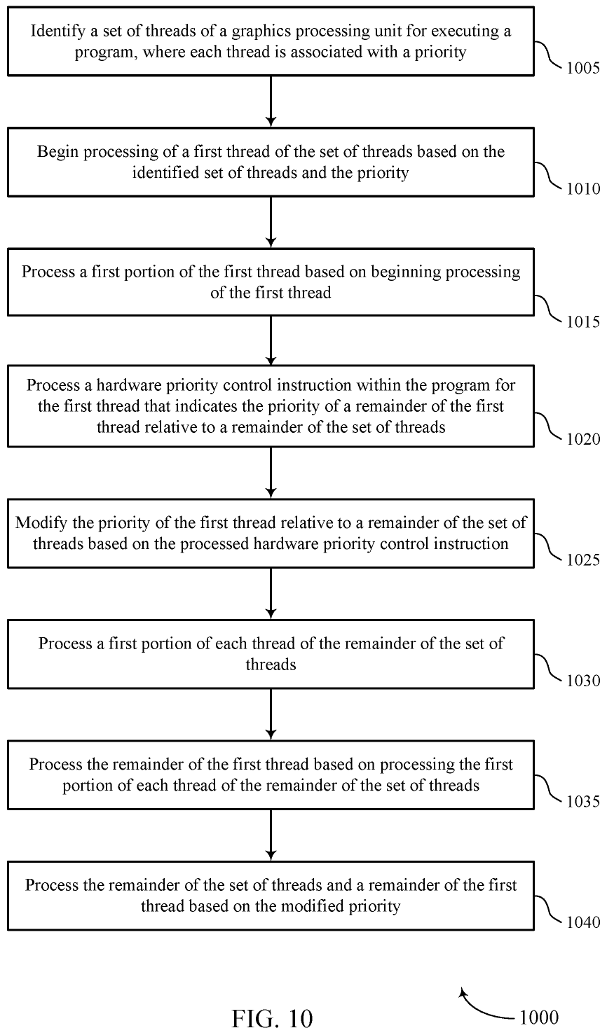

FIG. 10 shows a flowchart illustrating a method 1000 that supports shader controlled wave scheduling priority in accordance with one or more aspects of the present disclosure. The operations of method 1000 may be implemented by a device or its components as described herein. For example, the operations of method 1000 may be performed by a graphics manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 1005, the device may identify a set of threads of a graphics processing unit for executing a program, where each thread is associated with a priority. The operations of 1005 may be performed according to the methods described herein. In some examples, aspects of the operations of 1005 may be performed by a thread priority manager as described with reference to FIGS. 4 through 7.

At 1010, the device may begin processing of a first thread of the set of threads based on the identified set of threads and the priority. The operations of 1010 may be performed according to the methods described herein. In some examples, aspects of the operations of 1010 may be performed by a thread processing manager as described with reference to FIGS. 4 through 7.

At 1015, the device may process a first portion of the first thread based on beginning processing of the first thread. The operations of 1015 may be performed according to the methods described herein. In some examples, aspects of the operations of 1015 may be performed by a thread processing manager as described with reference to FIGS. 4 through 7.

At 1020, the device may process a hardware priority control instruction within the program for the first thread that indicates the priority of a remainder of the first thread relative to a remainder of the set of threads. The operations of 1020 may be performed according to the methods described herein. In some examples, aspects of the operations of 1020 may be performed by a processing instruction manager as described with reference to FIGS. 4 through 7.

At 1025, the device may modify the priority of the first thread relative to a remainder of the set of threads based on the processed hardware priority control instruction (e.g., based on a processed instruction variant controlled by the shader). The operations of 1025 may be performed according to the methods described herein. In some examples, aspects of the operations of 1025 may be performed by a thread priority manager as described with reference to FIGS. 4 through 7.

At 1030, the device may process a first portion of each thread of the remainder of the set of threads. The operations of 1030 may be performed according to the methods described herein. In some examples, aspects of the operations of 1030 may be performed by a thread processing manager as described with reference to FIGS. 4 through 7.

At 1035, the device may process the remainder of the first thread based on processing the first portion of each thread of the remainder of the set of threads. The operations of 1035 may be performed according to the methods described herein. In some examples, aspects of the operations of 1035 may be performed by a thread processing manager as described with reference to FIGS. 4 through 7.

At 1040, the device may process the remainder of the set of threads and a remainder of the first thread based on the modified priority. For example, in some cases, the shader may include one or more instruction variants such that the device may process hardware priority control instructions after each first portion of the processed threads. As such, the device may process a first portion (e.g., some critical section, an initial wave, first loop iteration, etc.) of each thread prior to processing the remainder of each thread. The operations of 1040 may be performed according to the methods described herein. In some examples, aspects of the operations of 1040 may be performed by a thread processing manager as described with reference to FIGS. 4 through 7.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for graphics processing at a device, comprising:
identifying a set of threads of a graphics processing unit for executing a program, wherein each thread is associated with a priority;
beginning processing of a first thread of the set of threads based at least in part on the identified set of threads and the priority;
modifying the priority of the first thread relative to a remainder of the set of threads based at least in part on beginning processing of the first thread; and
processing the remainder of the set of threads and a remainder of the first thread based at least in part on the modified priority.

2. The method of claim 1, further comprising:
processing a first portion of the first thread based at least in part on beginning processing of the first thread, wherein the priority of the first thread relative to the remainder of the set of threads is modified based at least in part on processing the first portion of the first thread.

3. The method of claim 2, wherein the first portion of the first thread comprises a first loop of a load operation, a long sync operation, and an arithmetic logic unit operation, and the remainder of the first thread comprises one or more loops other than the first loop.

4. The method of claim 1, further comprising:
determining one or more operations of the remainder of the set of threads is of higher priority than the remainder of the first thread, wherein the priority of the first thread relative to the remainder of the set of threads is modified based at least in part on the determination.

5. The method of claim 1, wherein modifying the priority of the first thread relative to the remainder of the set of threads comprises:
processing a hardware priority control instruction within the program for the first thread that indicates the priority of the remainder of the first thread relative to the remainder of the set of threads.

6. The method of claim 5, wherein the hardware priority control instruction comprises one or more of: a set-lowest-priority instruction, a set-highest-priority instruction, a lower-priority-by-N instruction, a raise-priority-by-N instruction, and a set-priority-to-N instruction.

7. The method of claim 5, wherein the priority of the remainder of the first thread relative to the remainder of the set of threads is modified based at least in part on a number of available arithmetic logic unit resources or a number of threads in the set of threads of the graphics processing unit.

8. The method of claim 1, wherein processing the remainder of the set of threads and the remainder of the first thread comprises:
processing a first portion of each thread of the remainder of the set of threads; and
processing the remainder of the first thread based at least in part on processing the first portion of each thread of the remainder of the set of threads.

9. The method of claim 8, further comprising:
modifying the priority of at least one thread of the remainder of the set of threads relative to the first thread based at least in part on processing the first portion of each thread of the remainder of the set of threads, wherein the remainder of the first thread is processed based at least in part on the modified priority of the at least one thread of the remainder of the set of threads.

10. The method of claim 1, wherein processing the remainder of the set of threads and the remainder of the first thread based at least in part on the modified priority comprises:
processing a first arithmetic logic unit operation associated with a second thread of the remainder of the set of threads; and
processing a second arithmetic logic unit operation associated with the remainder of the first thread based at least in part on processing the first arithmetic logic unit operation associated with the second thread.

11. An apparatus for graphics processing at a device, comprising:
a processor,
memory coupled with the processor; and
instructions stored in the memory and executable by the processor to cause the apparatus to:
identify a set of threads of a graphics processing unit for executing a program, wherein each thread is associated with a priority;
begin processing of a first thread of the set of threads based at least in part on the identified set of threads and the priority;
modify the priority of the first thread relative to a remainder of the set of threads based at least in part on beginning processing of the first thread; and
process the remainder of the set of threads and a remainder of the first thread based at least in part on the modified priority.

12. The apparatus of claim 11, wherein the instructions are further executable by the processor to cause the apparatus to:
process a first portion of the first thread based at least in part on beginning processing of the first thread, wherein the priority of the first thread relative to the remainder of the set of threads is modified based at least in part on processing the first portion of the first thread.

13. The apparatus of claim 12, wherein the first portion of the first thread comprises a first loop of a load operation, a long sync operation, and an arithmetic logic unit operation, and the remainder of the first thread comprises one or more loops other than the first loop.

14. The apparatus of claim 11, wherein the instructions are further executable by the processor to cause the apparatus to:
determine one or more operations of the remainder of the set of threads is of higher priority than the remainder of the first thread, wherein the priority of the first thread relative to the remainder of the set of threads is modified based at least in part on the determination.

15. The apparatus of claim 11, wherein the instructions to modify the priority of the first thread relative to the remainder of the set of threads are executable by the processor to cause the apparatus to:
process a hardware priority control instruction within the program for the first thread that indicates the priority of the remainder of the first thread relative to the remainder of the set of threads.

16. The apparatus of claim 15, wherein the hardware priority control instruction comprises one or more of: comprises a set-lowest-priority instruction, a set-highest-priority instruction, a lower-priority-by-N instruction, a raise-priority-by-N instruction, and a set-priority-to-N instruction.

17. The apparatus of claim 15, wherein the priority of the remainder of the first thread relative to the remainder of the set of threads is modified based at least in part on a number of available arithmetic logic unit resources or a number of threads in the set of threads of the graphics processing unit.

18. The apparatus of claim 11, wherein the instructions to process the remainder of the set of threads and the remainder of the first thread are executable by the processor to cause the apparatus to:
process a first portion of each thread of the remainder of the set of threads; and
process the remainder of the first thread based at least in part on processing the first portion of each thread of the remainder of the set of threads.

19. The apparatus of claim 18, wherein the instructions are further executable by the processor to cause the apparatus to:
modify the priority of at least one thread of the remainder of the set of threads relative to the first thread based at least in part on processing the first portion of each thread of the remainder of the set of threads, wherein the remainder of the first thread is processed based at least in part on the modified priority of the at least one thread of the remainder of the set of threads.

20. An apparatus for graphics processing at a device, comprising:
means for identifying a set of threads of a graphics processing unit for executing a program, wherein each thread is associated with a priority;
means for beginning processing of a first thread of the set of threads based at least in part on the identified set of threads and the priority;
means for modifying the priority of the first thread relative to a remainder of the set of threads based at least in part on beginning processing of the first thread; and
means for processing the remainder of the set of threads and a remainder of the first thread based at least in part on the modified priority.
